(19) United States
(12) Patent Application Publication
(10) Pub. No.: US 2016/0327433 A1
(43) Pub. Date: Nov. 10, 2016

(54) TITLE: INTEGRATED PACKAGING FOR MULTI-COMPONENT SENSORS

(71) Applicant: EMPIRE TECHNOLOGY DEVELOPMENT LLC, Wilmington, DE (US)

(72) Inventor: Mordehai MARGALIT, Zichron Yaaqov (IL)

(73) Assignee: EMPIRE TECHNOLOGY DEVELOPMENT LLC, Wilmington, DE (US)

(21) Appl. No.: 15/110,981

(22) PCT Filed: Sep. 8, 2014
(86) PCT No.: PCT/US14/54580

§ 371 Date: Jul. 12, 2016

(51) Int. Cl. G01J 3/42; G01J 3/10; G01J 3/02; G01N 21/27

(52) U.S. Cl. CPC G01J 3/42; G01N 21/27; G01J 3/10; G01J 3/0264; G01J 3/0224; G01N 2201/062; G01N 2201/0612; G01N 2201/0638; G01N 2201/0636; G01N 2201/0683

(57) ABSTRACT

Technologies are generally described for fabrication of a multi-component device, and employment thereof. The device may include a substrate, and a multitude of light sources and one or more photo detectors positioned on a surface of the substrate. The light sources may be configured to illuminate at least a portion of an object with light, and the photo detectors may be configured to detect reflected light from the object in response to the illumination. In some examples, the reflected light may be analyzed to determine a spectral profile of the object. The device may further include a structure applied to the substrate adjacent to the photo detectors, where the structure may be configured to reduce direct light transmission from the light sources to the photo detectors. The structure may include a deposited material, a protrusion, and/or a recession on the surface of the substrate, for example.

### BACKGROUND

Unless otherwise indicated herein, the materials described in this section are not prior art to the claims in this application and are not admitted to be prior art by inclusion in this section.

In a variety of scientific, industrial, financial, and legal activities, for example, spectroscopic information may need to be acquired from a sample area of an object to evaluate the object. A multi-component sensor may be configured to determine a spectral profile of the object, among other functions. In some examples, the multi-component sensors may further be configured to determine an identity and/or one or more characteristics of the object based on the spectral profile. The characteristics may include an authenticity, a quality, a density, a reflectivity, and/or an amount of the object that may be used to evaluate the object.

The multiple components of the sensor may require an electrical, optical and thermal connection to a controller of the sensor that may be enhanced through integration of the components during fabrication. Such integrated multi-component sensors may allow enhanced performance at a lower cost. Accordingly, current attempts to fabricate devices with multiple integrated components could use improvements and/or alternative or additional solutions, such that low-cost, high performance, and small-form fabrication may be achieved.

### SUMMARY

The present disclosure generally describes techniques to fabricate and employ a device with multiple integrated components.

According to some examples, apparatuses with multiple integrated components may be described. An example apparatus may include a substrate, one or more photo detectors positioned on a surface of the substrate, and light sources positioned on the surface of the substrate, where the light sources are arranged such that each photo detector has a plurality of adjacent light sources. The example apparatus may also include a structure positioned on the substrate adjacent to each photo detector, the structure configured to reduce direct light transmission from the light sources to the one or more photo detectors.

According to other examples, methods to fabricate a multi-component apparatus are provided. An example method may include forming a substrate, positioning one or more photo detectors on a surface of the substrate, and positioning light sources on the surface of the substrate, where the light sources are arranged such that each photo detector has a plurality of adjacent light sources. The example method may also include applying a structure on the substrate adjacent to each photo detector, the structure configured to reduce direct light transmission from the light sources to the photo detectors.

According to further examples, methods to employ an apparatus with multiple integrated components are provided. An example method may include illuminating at least one portion of an object with light at a variety of wavelengths from a plurality of light sources positioned on a surface of a substrate, and detecting reflected light from the portion of the object in response to the illumination at one or more photo detectors positioned on the surface of the substrate. The example method may also include reducing light directed to the photo detectors other than the reflected light from the portion of the object illuminated by the plurality of light sources through a structure applied to the substrate adjacent to the photo detectors.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 illustrates an example device with multiple integrated components;

FIGS. 2A-2C illustrate an example fabrication process of a device with multiple integrated components;

FIG. 3 illustrates an example smart phone including a device with multiple integrated components

FIG. 4 illustrates an example system to fabricate a device with multiple integrated components;

FIG. 5 illustrates a general purpose computing device, which may be used to fabricate a device with multiple integrated components;

FIG. 6 is a flow diagram illustrating an example process to fabricate a device with multiple integrated components that may be performed by a computing device such as the computing device in FIG. 5; and

FIG. 7 illustrates a block diagram of an example computer program product, all arranged in accordance with at least some embodiments described herein.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. The aspects of the present disclosure, as generally described herein, and illustrated in the Figures, can be arranged, substituted, combined, separated, and designed in a wide variety of different configurations, all of which are explicitly contemplated herein.

This disclosure is generally drawn, among other things, to methods, apparatus, systems, devices, and/or computer program products related to fabrication and/or employment of a multi-component device configured to determine a spectral profile of an object.

Briefly stated, technologies are generally described for fabrication of a multi-component device, and employment thereof. The device may include a substrate, and a multitude of light sources and one or more photo detectors positioned on a surface of the substrate. The light sources may be configured to illuminate at least a portion of an object with light, and the photo detectors may be configured to detect reflected light from the object in response to the illumination. In some examples, the reflected light may be analyzed to determine a spectral profile of the object. The device may further include a structure applied to the substrate adjacent to the photo detectors, where the structure may be configured to reduce direct light transmission from the light sources to the photo detectors. The structure may include a deposited material, a protrusion, and/or a recession on the surface of the substrate, for example.

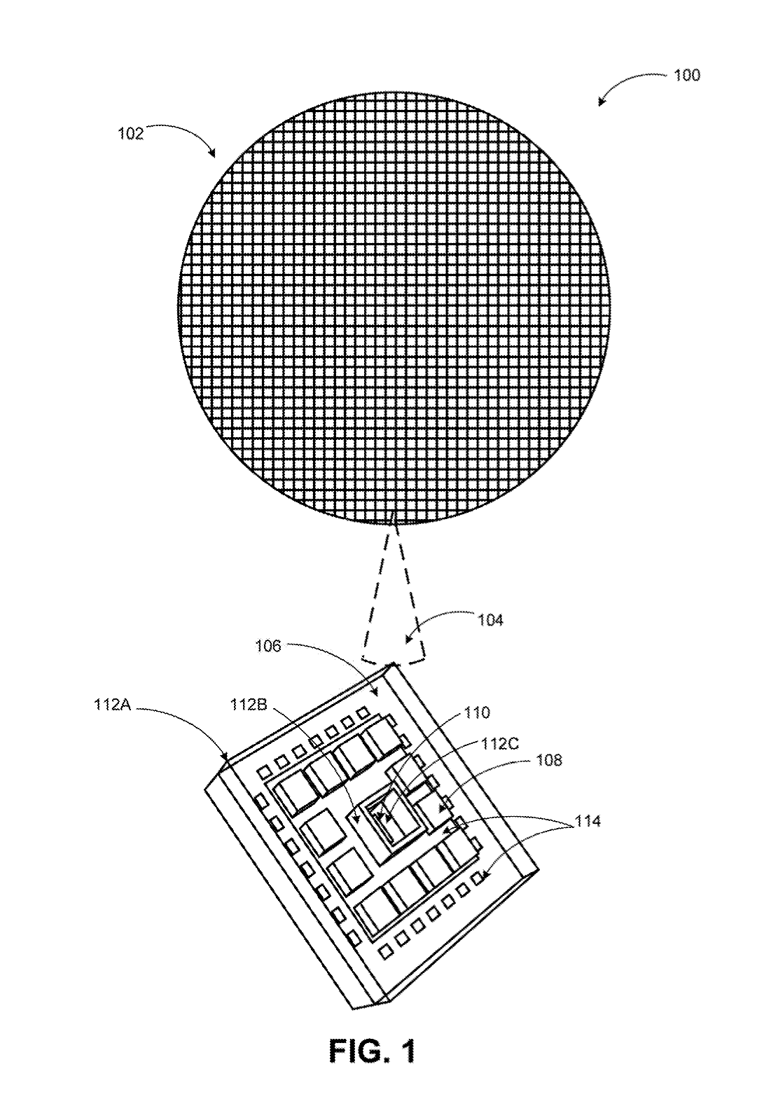

FIG. 1 illustrates an example device with multiple integrated components, arranged in accordance with at least some embodiments described herein.

As shown in a diagram 100, an example wafer and/or chip 102 may comprise a multitude of multi-component devices, such as device 104. The device 104 may include a substrate 106, a multitude of light sources 108, one or more photo detectors 110, and at least one electrical connection 114. In some embodiments, the device 104 may also include one or more structures (for example, 112A-C) that may be applied to the substrate 106.

The substrate 106 may be formed from a first material that includes ceramic, silicon, metal oxide, gallium arsenide, glass, polymer, and/or resin. The substrate 106 may be configured to provide a mechanical fixture for placing optoelectronic components. For example, the light sources 108 and the photo detectors 110 may be positioned on a surface of the substrate 106 through wire bonding or flip chip bonding. The light sources 108 may be arranged such that each of the photo detectors 110 has a plurality of adjacent light sources 108. In some examples, at least one of the photo detectors 110 may share at least one of the adjacent light sources 108 with another proximate photo detector.

In some embodiments, the light sources 108 may surround each of the photo detectors 110, where the photo detectors 110 are positioned centrally on the surface of the substrate 106, as illustrated. In other embodiments, the photo detectors may be arranged on the surface of the substrate 106 in a linear array or in a two-dimensional arrangement, such as a square array or a hexagonal array. The device 104, when comprising the photo detectors 110 arranged in the linear array, may be translated over an object of interest (for example, along a direction orthogonal to the direction of elongation of the array) to obtain spectral data from a two-dimensional array of sample areas on a surface of the object to determine a spectral profile. The device 104, when comprising the photo detectors arranged in the two-dimensional arrangement, may be placed adjacent to the object of interest, and spectral data from a two-dimensional array of sample areas on the surface of the object may be obtained to determine the spectral profile.

The light sources 108 may have different emission spectra and may include light emitting diodes (LEDs), laser diodes, white light sources, UV light sources, infrared light sources, red light sources, orange light sources, yellow light sources, green light sources, blue light sources, and/or violet light sources, for example. The light sources 108 may be configured to illuminate at least one portion of an object with light at a variety of wavelengths in a sequential order or a random order for a pre-defined period of time. The object may be the object of interest previously discussed, for example, which may include a substance, product, specimen and/or document. In some examples, the light sources 108 may be selected based on an identity and/or color of the object being illuminated. The photo detectors 110 may include photodiodes, photomultiplier tubes, complementary metal oxide semiconductor (CMOS) image sensors, charged coupled devices (CCDs), and/or micro-channel plates, for example. The photo detectors 110 may be configured to detect reflected light from the portion of the object in response to the illumination.

One or more of the light sources may be operable to emit the light at wavelengths in part or in all of an optical portion of the electromagnetic spectrum, including the visible portion, near-infrared portion and/or near ultraviolet portions of the electromagnetic spectrum. Additionally, or alternatively, the light sources may be operable to emit light at wavelengths in other portions of the electromagnetic spectrum, such as as the infrared, ultraviolet, and/or microwave portions.

In some embodiments, at least one of the light sources may be operable to emit the light in or at a different wavelength the other light sources. For example, one or more of the light sources may emit the light at a wavelength around 450 nm, one or more light sources may emit the light at a wavelength around 500 nm, and at least one of the light sources may emit the light at a wavelength around 550 nm. In some embodiments, each of the light sources may emit light at a different wavelength. Using light sources that emit light at different wavelengths may maximize a number of distinct samples that may be captured from a fixed number of light sources. This may be of particular use when the multi-component device is small, and/or has limited space or footprint for the light sources.

The distribution of spectral content for each of the light sources may vary as a function of drive level (for example, current, voltage, and duty cycle), temperature, and/or other environmental factors, depending on a type of the light sources. Such variation may be actively employed to operate one or more of the physical light sources as a plurality of “logical light sources”, where each of the logical light sources may be operable to provide a respective emission spectra from a respective physical source. For example, a peak wavelength at which each of the light sources emits light may be varied by altering and/or adjusting a drive level and/or a temperature. Adjustment of the drive level and/or temperature may cause the peak wavelength to shift, allowing each of the light sources to emit light at a different wavelength such that the portion of the object may be illuminated with light at a variety of different wavelengths.

In some examples, the device 104 may include a converging lens configured such that the photo detectors 110 and the light sources 108 are at least approximately located on or proximate the focal plane of the lens. As the light sources 108 sequentially illuminate the portion of the object with light, the light reflected from the portion of the object may then be returned from the surface of the portion of the object, incident on the lens, and then at least approximately focused on the photo detectors 110. In further examples, the device 104 may include a control circuit. The control circuit may be configured to detect a signal from at least one of the photo detectors 110 while sequentially illuminating each of the light sources 108.

The reflected light may be analyzed to determine a spectral profile of the portion of the object, where the spectral profile may be used to further determine an identity and/or one or more characteristics of the object, such as a quality, authenticity, density, reflectivity, and/or an amount of the object. In an example scenario, a law enforcement officer may be able to employ the device 104 to identify an unknown white substance found in a car during a routine stop for a traffic violation. The light sources 108 may be configured to illuminate an object at the same wavelength or at different wavelengths simultaneously, sequentially, or in random order. In example operations, one, all, or a subset of the light sources 108 may be used to illuminate the object.

In other embodiments, when at least one of the photo detectors 110 is an image sensor, the photo detectors 110 may be further configured to collect images for each illumination wavelength. Multiple color light sources, such as red light sources, orange light sources, yellow light sources, green light sources, blue light sources, and/or violet light sources, may surround each of the photo detectors 110. In some examples, the photo detectors 110 may be color sensitive at a particular illumination wavelength. When the light sources 108 illuminate the portion of the object at the particular wavelength, the sensitive photo detectors 110 may be turned off and other sensors may be used to collect the images at the particular wavelength, such as UV light sources and infrared light sources. For example, the UV light sources may be used to collect fluorescence data. In some embodiments, image data may be collected as a multitude of images under different color light illumination that may include UV, violet, blue, cyan, green, yellow, orange, red, and/or near-IR illumination, where time-dependent data may be collected. In other embodiments, the image data may be collected from the photo detectors 110 upon sequential illumination of light sources having a same color. For example, all red light sources may be illuminated together, and corresponding reflectance data may be collected for each of the photo detectors 110. Then, all blue light sources may be illuminated, and corresponding reflectance data may be collected for each of the photo detectors.

The electrical connection 114 may be formed on one or more surfaces of the substrate 106 by patterning and metallizing the surfaces of the substrate 106. Metallization may include depositing gold, copper, aluminum, silver, titanium, chrome, tin, tungsten, and/or combinations of these metals. In some examples, the metal areas may be fabricated as two metal layers with an isolating layer between the metal layers. The patterned metal areas may define connectors or other functional electric components. For example, the patterned metal areas may be resistors, inductors or capacitors. Furthermore, the patterned metal areas forming the electrical connection 114 on a surface of the substrate 106 may include bonding pads configured to accommodate positioning of the light sources 108 and the photo detectors 110 on the surface of the substrate 106. An electrical connection formed on an opposite surface of the substrate 106 from the light sources 108 and the photo detectors 110 may allow attachment of the substrate 106 to an electronic printed circuit board (PCB). The electrical connection to the PCB may be formed using a tin-based solder, or using wire bonding techniques, for example.

The structures applied to the substrate 106 may include a deposited second material 112A, a protrusion 112B, and/or a recession 112C on the surface of the substrate, for example, where the structures may be applied adjacent to each of the photo detectors 110. The second material 112A may be deposited on the surface of the substrate 106 such that the second material 112A encompasses the light sources 108 and the one or more photo detectors 110, where the second material 112A may include a glass, a plastic, and/or a polymer. In some examples, one or more optical elements may be etched or embossed on the second material 112A. The optical elements may include lenses, reflectors, and/or partial reflectors that are configured to reflect light, partially reflect light, or occlude light. The protrusion 112B may be formed from the first material, and may be positioned centrally on the surface of the substrate 106 configured to substantially surround the photo detectors 110 and exclude the light sources 108. The recession 112C may be positioned centrally on the surface of the substrate 106 such that the photo detectors 110 are positioned at a greater distance away from the surface of the substrate 106 compared to the light sources 108. The structures may be configured to reduce direct light transmission from the light sources 108 to the photo detectors, and accordingly reduce light directed to the photo detectors 110 other than the reflected light from the portion of the object illuminated by light sources 108.

In some embodiments, one or more polarizing elements may be integrated with the light sources 108 and the photo detectors 110, where the polarizing elements may be configured to provide a glare control, a discrimination of roughness variations, and a relative stress indication, for example. Furthermore, the device 104 may include at least one light blocking filter, where the filter may be configured to further reduce direct light transmission from the light sources 108 to the photo detectors 110.

By incorporating the multitude of multi-component devices, such as the device 104 into the wafer and/or chip 102, wafer level packaging practices may be used providing low cost, small-form, and high volume fabrication of the multi-component devices. For example, the wafer and/or chip 102 comprising the multitude of devices may be merely 200 millimeters (mm) in diameter. In some embodiments, the small-form fabrication of the multi-component devices may provide portability and further integration opportunities that extends the functionality of the device 104. For example, the device 104 may be integrated with a pen, a flashlight, a camera, a smart phone, a head-mounted display, and/or a Radio-Frequency Identification (RFID) reader, among other examples. In the above described scenario, the device 104 may be integrated with a flashlight for a convenience of the law enforcement officer, for example, enabling the officer to employ the device 104 on-site to identity the unknown white substance found. If the substance is identified as an illegal substance, the officer may take immediate action prior to the perpetrator being released.

In further examples, if image data is collected by the photo detectors 110, the image data may be transmitted to a portable electronic device, such as the smart phone or head-mounted display, and displayed on the display thereof. For example, the device 104 may be located adjacent to the image sensor and/or camera of the smart phone. A user may identify an object by capturing an image of the object employing the image sensor, and viewing the image of the object on a display screen of the smart phone. The spatial location and extent of the portion of the object to be illuminated may be adjusted using, for example, the optical elements within the device 104, where an element on the display screen may indicate which portions of the object would be illuminated by the device 104. Additionally, one or more of the light sources 108 of the device 104 may be operated by the smart phone such that an optical signal from the light sources 108 of the device 104 may be displayed on the screen of the smart phone. The display of the optical signal may guide the user to position the smart phone such that a spectral response of the object of interest may be acquired. In another example, the device 104 may be integrated with a head-mounted display, such as a smart glass device. In this scenario, the light sources 108 of the device 104 may emit light in the direction of viewing. The user can either view a location of the light directly or by using an image sensor and augmented reality capabilities of the smart glass.

In some examples, an application on the portable electronic device may be used to control the device 104, where operation of the device 104 may be executed by the application stored in a memory of the portable electronic device, and processed by a processor coupled to the memory. For example, once a desired portion of the object for illumination is selected, a displayed button icon on the screen of the portable electronic device may be touched, initiating collection of spectral data to determine the spectral profile. The spectral data may be displayed and/or stored in the memory of the portable electronic device together with the image of the portion of the object from which it was collected.

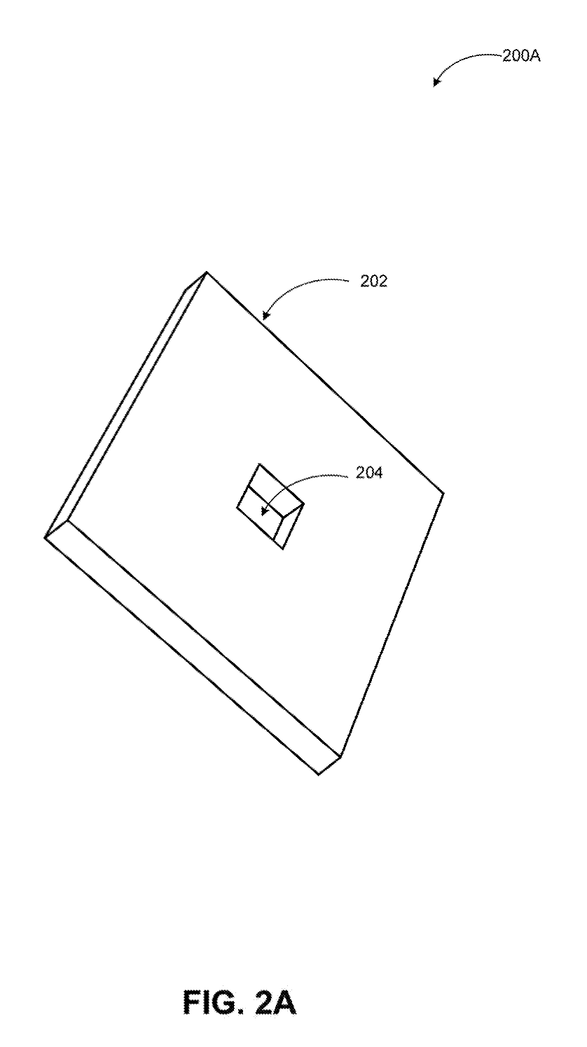

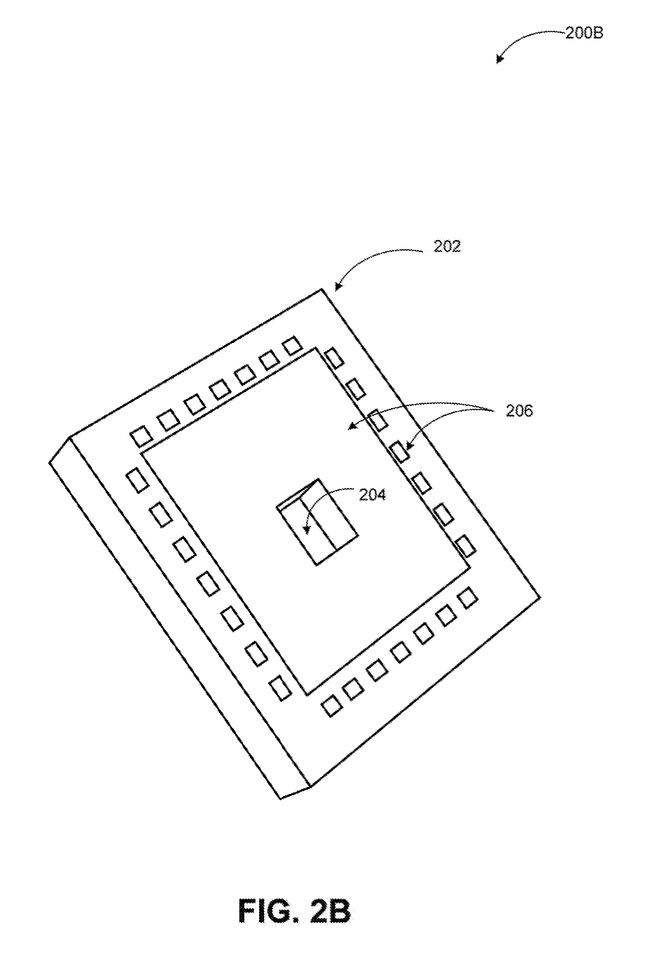

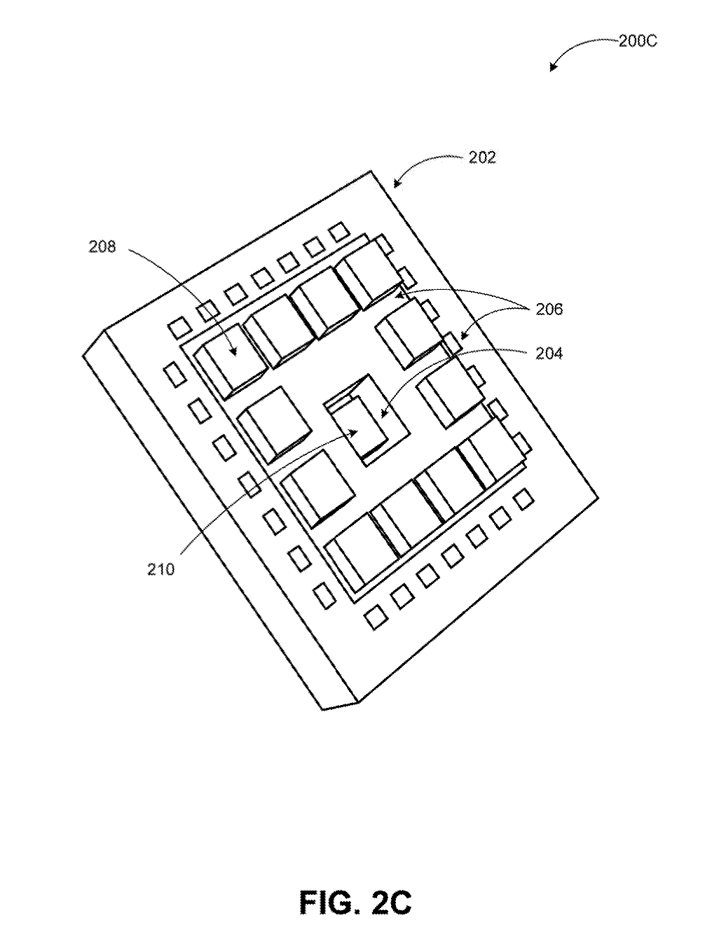

FIGS. 2A-2C illustrate an example fabrication process of a device with multiple integrated components, arranged in accordance with at least some embodiments described herein.

In FIG. 2A, diagram 200A, a substrate 202 may be formed to provide a mechanical fixture for placing optoelectronic components. The substrate 202 may be formed from a first material that includes ceramic, silicon, metal oxide, gallium arsenide, glass, polymer, and/or resin, for example. A recession 204 may then be formed in the substrate 202 using semiconductor processes, such as Deep Reactive Ion Etching (DRIE). The recession 204 may be positioned centrally on a surface of the substrate 202.

In FIG. 2B, diagram 200B, one or more electrical connections 206 may be formed on the substrate 202. The electrical connections may be formed on one or more surfaces of the substrate 202 by patterning and metallizing the surfaces of the substrate 202. Metallization may include depositing gold, tin, solder, copper, and/or aluminum, for example. The electrical connection 206 on a surface of the substrate 202 may include bonding pads configured to accommodate positioning of the optoelectronic components, such as light sources and photo detectors, on the surface of the substrate 202. An electrical connection on an opposite surface of the substrate 202 from the optoelectronic components may allow attachment of the substrate 202 to an electronic printed circuit board (PCB).

In FIG. 2C, diagram 300C, a multitude of light sources 208 and one or more photo detectors 210 may be positioned on the surface of the substrate 202 through wire bonding or flip chip bonding. The light sources 208 may be arranged such that each of the photo detectors 210 has a plurality of adjacent light sources 208 having different emission spectra. In some examples, the light sources 208 may surround each of the photo detectors 210, where the photo detectors 210 are positioned centrally on the surface of the substrate 202. Furthermore, the photo detectors 210 may be positioned within the recession 204 such that the photo detectors 210 are a greater distance away from the surface of the substrate 202 compared to the light sources 208. As a result of the position of the photo detectors 210 within the recession 204, direct light transmission from the light sources 208 to the photo detectors 210 may be reduced.

The light sources 208 may be configured to sequentially illuminate at least one portion of an object with light. In some embodiments, the light sources 208 may be configured to illuminate at least one portion of an object with light at a variety of wavelengths in a sequential order or a random order for a pre-defined period of time. The photo detectors 210 may be configured to detect reflected light from the portion of the object in response to the illumination. In some examples, the device may further include a control circuit configured to detect a signal from at least one of the photo detectors 210 while sequentially illuminating each of the light sources 208.

In other embodiments, additional structures may be applied to the substrate 202 adjacent to each of the photo detectors 210 to further reduce the direct light transmission from the light sources 208 to the photo detectors 210. For example, light other than the reflected light from the portion of the object directed to the photo detectors 210 may be reduced. The additional structures may include a second material deposited on the surface of the substrate 202 such that the second material encompasses the light sources 208 and the photo detectors 210, acting as a cover. The additional structures may also include a protrusion formed from the first material and positioned centrally on the surface of the substrate 202 such that the protrusion substantially surrounds the photo detectors 210 and excludes the light sources 208, acting as a wall.

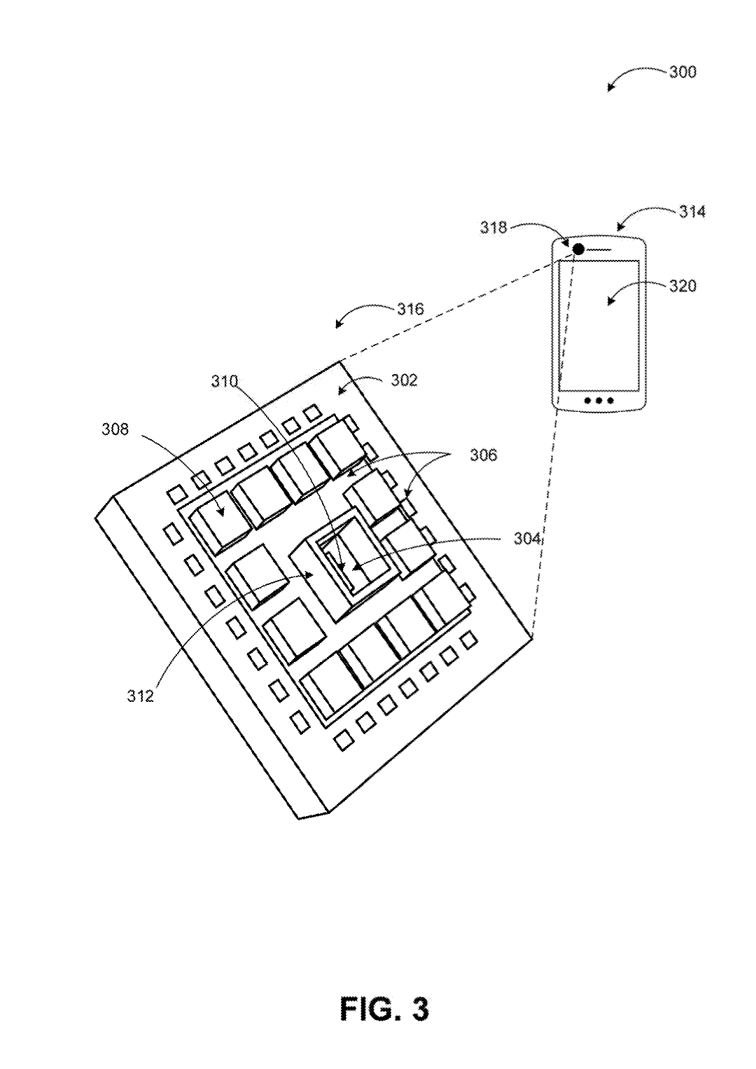

FIG. 3 illustrates an example smart phone including a device with multiple integrated components, arranged in accordance with at least some embodiments described herein.

As shown in a diagram 300, a smart phone 314 may be integrated with a multi-component device 316, the multi-component device 316 located adjacent to a camera 318 of the smart phone 314. The multi-component device 316 may include a substrate 302, a multitude of light sources 308, one or more photo detectors 310, and at least one electrical connection 306 on one or more surfaces of the substrate 302. In some embodiments, the multi-component device 316 may further include one or more structures (for example, 304 and 312) that may be applied to the substrate 302. In some examples, an application on the smart phone 314 may be used to control the multi-component device 316, where operation of the multi-component device 316 may be executed by the application stored in a memory of the smart phone 314, and processed by a processor coupled to the memory. In other examples, the multi-component device 316 may be integrated with other devices, such as a head-mounted display, a camera, a scanner, a pen, a flashlight, and other similar devices.

The substrate 302 may be formed from a first material that includes ceramic, silicon, metal oxide, gallium arsenide, glass, polymer, and/or resin, for example. A recession 304 may be formed in the substrate 302 using DRIE, for example, where the recession 204 may be positioned centrally on a surface of the substrate 302. The substrate 302 may provide a mechanical fixture for placing optoelectronic components, and the electrical connection 306 on a surface of the substrate 302 may accommodate a positioning of the optoelectronic components on the surface of the substrate 302. For example, a multitude of light sources 308 and one or more photo detectors 310 may be positioned on the surface of the substrate 302 through wire bonding or flip chip bonding. The light sources 308 may be arranged such that each of the photo detectors 310 has a plurality of adjacent light sources 208 having different emission spectra. In some examples, the light sources 308 may surround each of the photo detectors 310, where the photo detectors 210 are positioned centrally on the surface of the substrate 302. Furthermore, the photo detectors 310 may be positioned within the recession 304 such that the photo detectors 310 are a greater distance away from the surface of the substrate 302 compared to the light sources 308. As a result of the position of the photo detectors 310 within the recession 304, direct light transmission from the light sources 308 to the photo detectors 310 may be reduced.

Additionally, a protrusion 312 may formed on the surface of the substrate from the first material to further reduce direct light transmission from the light sources 308 to the photo detectors 210. The protrusion 312 may be positioned centrally on the surface of the substrate 302 and configured to substantially surround the photo detectors 310 and exclude the light sources 308. In other embodiments, additional structures to further reduce direct light transmission from the light sources 308 to the photo detectors 310 may be applied to the substrate 302 adjacent to the photo detectors 310. For example, a second material may be deposited on the surface of the substrate 302 such that the second material encompasses the light sources 308 and the photo detectors 310, where the second material may include a glass, a plastic, and/or a polymer.

The light sources 308 may include LEDs, laser diodes, white light sources, UV light sources, infrared light sources, red light sources, orange light sources, yellow light sources, green light sources, blue light sources, and/or violet light sources, for example. The light sources 308 may be configured to illuminate at least one portion of an object with light at a variety of wavelengths in a sequential order or a random order for a pre-defined period of time. In some examples, the light sources 308 may be selected based on an identity and/or color of the object being illuminated. The photo detectors 310 may include photodiodes, photomultiplier tubes, CMOS image sensors, CCDs, and/or micro-channel plates, for example. The photo detectors may be configured to detect reflected light from the portion of the object in response to the illumination. In some examples, the device may include a control circuit configured to detect a signal from at least one of the photo detectors 310 while sequentially illuminating each of the light sources 308. In some embodiments, the reflected light may be analyzed to determine a spectral profile of the portion of the object, where the spectral profile may be used to further determine an identity and/or a characteristic of the object. For example, a bank teller may be suspicious of fraudulent bills entering the bank. The device may be employed to determine an authenticity of the bills based on the spectral profile determined from the analyzed reflected light.

In other embodiments, when at least one of the photo detectors 310 is an image sensor, the photo detectors 310 may be further configured to collect images for each illumination wavelength. Multiple color light sources, such as the red light sources, orange light sources, yellow light sources, green light sources, blue light sources, and/or violet light sources, may surround each of the photo detectors 310. In some examples, the photo detectors 310 may be color sensitive at a particular illumination wavelength. When the light sources illuminate the portion of the object at the particular wavelength, the sensitive photo detectors may be turned off and other sensors may be used to collect the images at the particular wavelength, such as UV light sources and infrared light sources.

In an example scenario, a user may identify an object by capturing an image of the object employing the camera 318 of the smart phone 314, and viewing the image of the object on a display screen 320 of the smart phone 314. The spatial location and extent of the portion of the object to be illuminated may be adjusted using the optical elements within the multi-component device 316, where an element on the display screen 320 may indicate which portions of the object would be illuminated by the light sources 308 of the multi-component device 316. Additionally, one or more of the light sources 308 may be operated by the smart phone 314 such that an optical signal from the light sources 308 may be displayed on the display screen 320 of the smart phone 314. The display of the optical signal may guide the user to position the smart phone 314 such that a spectral response of the object of interest may be acquired. Once a desired portion of the object for illumination is selected, a displayed button icon on the display screen 320 of the smart phone 314 may be touched, initiating collection of spectral data to determine the spectral profile. The spectral data may be displayed and/or stored in the memory of the smart phone together with the image of the portion of the object from which it was collected.

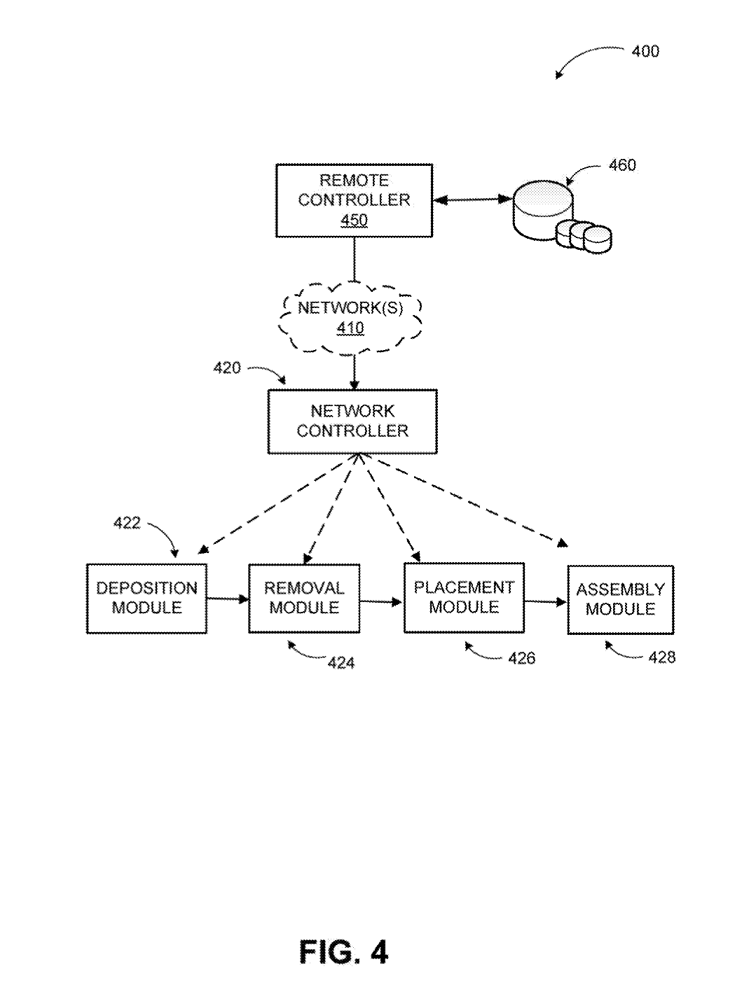

FIG. 4 illustrates an example system to fabricate a device with multiple integrated components, arranged in accordance with at least some embodiments described herein.

System 400 may include at least one controller 420, at least one deposition module 422, at least one removal module 424, at least one placement module 426, and at least one assembly module 428. The controller 420 may be operated by human control or may be configured for automatic operation, or may be directed by a remote controller 450 through at least one network (for example, via network 410). Data associated with controlling the different processes of assembly may be stored at and/or received from data stores 460.

The controller 420 may include or control the deposition module 422 configured to form a substrate from a first material. The first material may include ceramic, silicon, metal oxide, gallium arsenide, glass, polymer, and/or resin. The substrate may be configured to provide a mechanical fixture for placing optoelectronic components. The controller 420 may also include or control the removal module 424 configured to form a recession in the substrate. The recession may be positioned centrally on a surface of the substrate. Various deposition and removal techniques may be used by the deposition module 422 and removal module 424 including, but not limited to, chemical vapor deposition (CVD), low pressure CVD (LPCVD), atmospheric pressure CVD (APCVD), ultrahigh vacuum CVD (UHVCVD, atomic layering deposition (ALD), molecular layer deposition (MLD), plasma enhanced CVD (PECVD), metal-organic CVD (MOCVD), molecular beam epitaxy (MBE), sputter deposition, ion implantation, annealing, wet chemical etching, gaseous chemical etching, plasma etching, reactive ion etching (RIE), masking lithography, and/or chemical mechanical polishing (CMP).

The controller 420 may further include or control the placement module 426 configured to form one or more electrical connections on one or more surfaces of the substrate. The electrical connections may be formed by patterning and metallizing the surfaces of the substrate. Metallization may include depositing gold, tin, solder, copper, and/or aluminum, for example. An electrical connection in a form of a bonding pad, for example, on a surface of the substrate may accommodate a positioning of the optoelectronic components on the surface of the substrate. For example, a multitude of light sources and one or more photo detectors may be positioned on a surface of the substrate through wire bonding or flip chip bonding. The light sources may be arranged such that each of the photo detectors has a plurality of adjacent light sources having different emission spectra. In some examples, the light sources may surround each of the photo detectors, where the photo detectors are positioned centrally on the surface of the substrate. In other examples, the photo detectors may be positioned on the surface of the substrate in a linear array or in a two-dimensional arrangement, such as a square array or a hexagonal array. Furthermore, the photo detectors may be positioned within the recession such that the photo detectors are a greater distance away from the surface of the substrate compared to the light sources. As a result of the position of the photo detectors within the recession, direct light transmission from the light sources to the photo detectors may be reduced.

The controller 420 may further include or control the assembly module 428 configured to apply additional structures to the substrate adjacent to the photo detectors, where the additional structures may configured to further reduce direct light transmission from the light sources to the photo detectors. For example, light directed to the photo detectors other than a reflected light from a portion of an object illuminated by the light sources may be reduced. The additional structures may include a second material deposited on the surface of the substrate such that the second material encompasses the light sources and the photo detectors. In some examples, one or more optical elements may be etched or embossed on the second material. The optical elements may include lenses, reflectors, and/or partial reflectors that are configured to reflect light, partially reflect light, or occlude light. The additional structures may also include a protrusion formed from the first material and positioned centrally on the surface of the substrate such that the protrusion substantially surrounds the photo detectors and excludes the light sources.

The examples in FIGS. 1-4 have been described using specific apparatuses, configurations, and materials to fabricate and employ a multi-component device configured to illuminate an object and detect reflected light in response to the illumination in order to determine a spectral profile of an object. Fabrication of the multi-component device, and employment thereof, is not limited to the specific apparatuses, configurations, and materials according to these examples.

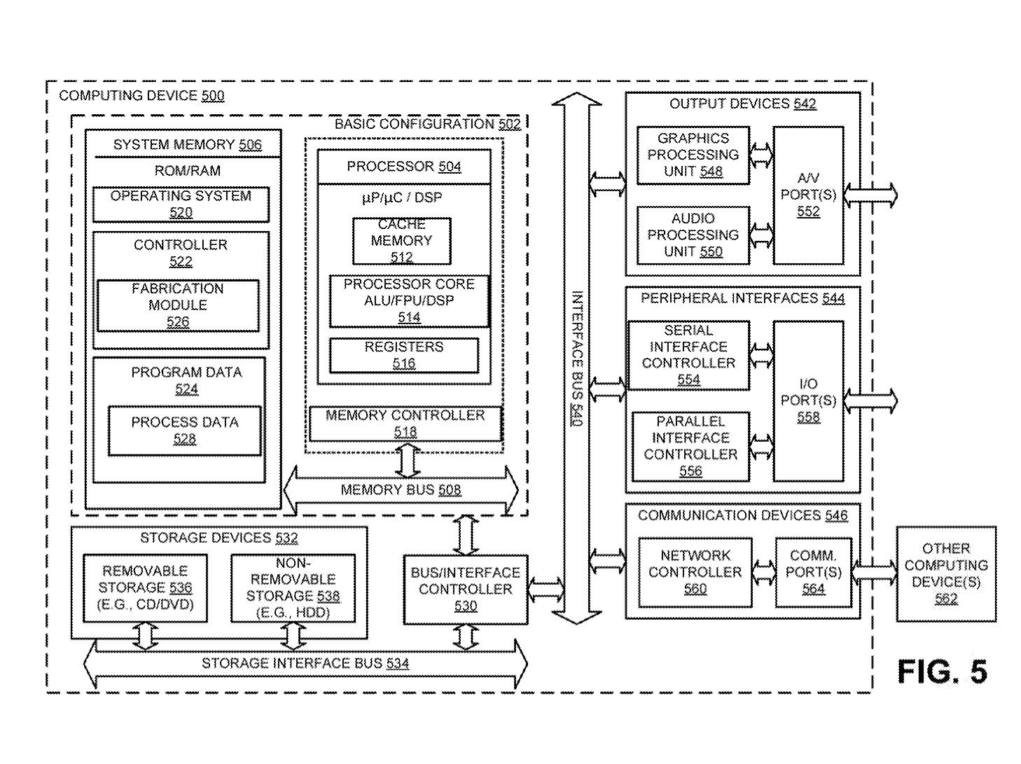

FIG. 5 illustrates a general purpose computing device, which may be used to fabricate a device with multiple integrated components, arranged in accordance with at least some embodiments described herein.

For example, a computing device 500 may be used as a server, desktop computer, portable computer, smart phone, special purpose computer, or similar device such as a controller. In an example basic configuration 502, the computing device 500 may include one or more processors 504 and a system memory 506. A memory bus 508 may be used for communicating between the processor 504 and the system memory 506. The basic configuration 502 is illustrated in FIG. 5 by those components within the inner dashed line.

Depending on the desired configuration, the processor 504 may be of any type, including but not limited to a microprocessor (μP), a microcontroller (μC), a digital signal processor (DSP), or any combination thereof. The processor 504 may include one more levels of caching, such as a level cache memory 512, one or more processor cores 514, and registers 516. The example processor cores 514 may (each) include an arithmetic logic unit (ALU), a floating point unit (FPU), a digital signal processing core (DSP Core), or any combination thereof. An example memory controller 518 may also be used with the processor 504, or in some implementations the memory controller 518 may be an internal part of the processor 504.

Depending on the desired configuration, the system memory 506 may be of any type including but not limited to volatile memory (such as RAM), non-volatile memory (such as ROM, flash memory, etc.) or any combination thereof. The system memory 506 may include an operating system 520, a controller application 522, and program data 524. The controller application 522 may include a fabrication module 526, which may be an integral part of the application or a separate application on its own. The fabrication module 526 may be configured to form a substrate, and position one or more photo detectors and light sources on a surface of the substrate, where the light sources are arranged such that each of the photo detectors has a multitude of adjacent light sources. The fabrication module 526 may be further configured to apply a structure to the substrate adjacent to each of the photo detectors such that direct light transmission from the light sources to the photo detectors is reduced. The program data 524 may include, among other data, process data 528, such as data related to fabrication of the multi-component apparatus, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more storage devices 532 via a storage interface bus 534. The storage devices 532 may be one or more removable storage devices 536, one or more non-removable storage devices 538, or a combination thereof. Examples of the removable storage and the non-removable storage devices include magnetic disk devices such as flexible disk drives and hard-disk drives (HDD), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer readable instructions, data structures, program modules, or other data.

The system memory 506, the removable storage devices 536, and the non-removable storage devices 538 are examples of computer storage media. Computer storage media includes, but is not limited to, RAM, ROM, EEPROM, flash memory or other memory technology, CD-ROM, digital versatile disks (DVDs), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 546) to the basic configuration 502 via the bus/interface controller 530. Some of the example output devices 542 include a graphics processing unit 548 and an audio processing unit 550, which may be configured to communicate to various external devices such as a display or speakers via one or more A/V ports 552. One or more example peripheral interfaces 544 may include a serial interface controller 554 or a parallel interface controller 556, which may be configured to communicate with external devices such as input devices (for example, keyboard, mouse, pen, voice input device, touch input device, etc.) or other peripheral devices (for example, printer, scanner, etc.) via one or more I/O ports 558. An example communication device 546 includes a network controller 560, which may be arranged to facilitate communications with one or more other computing devices 562 over a network communication link via one or more communication ports 564. The one or more other computing devices 562 may include servers, client devices, and comparable devices.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

The computing device 500 may be implemented as a part of a general purpose or specialized server, mainframe, or similar computer that includes any of the above functions. The computing device 500 may also be implemented as a personal computer including both laptop computer and non-laptop computer configurations.

Example embodiments may also include methods to employ the fabricated device with multiple integrated components. These methods can be implemented in any number of ways, including the structures described herein. One such way may be by machine operations, of devices of the type described in the present disclosure. Another optional way may be for one or more of the individual operations of the methods to be performed in conjunction with one or more human operators performing some of the operations while other operations may be performed by machines. These human operators need not be collocated with each other, but each can be only with a machine that performs a portion of the program. In other embodiments, the human interaction can be automated such as by pre-selected criteria that may be machine automated.

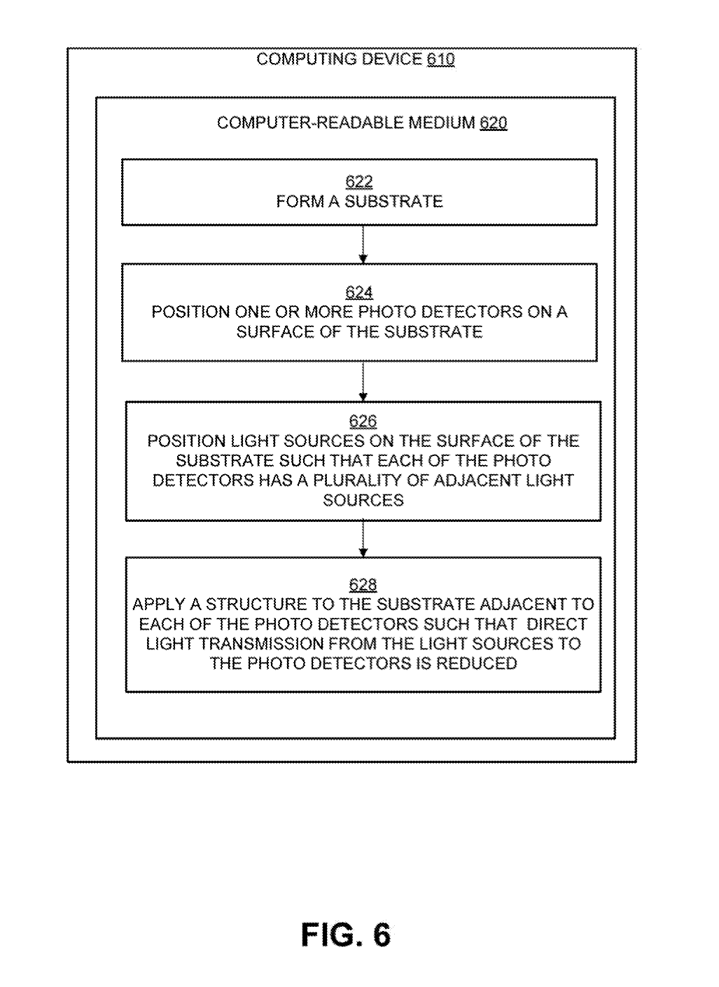

FIG. 6 is a flow diagram illustrating an example process to fabricate a device with multiple integrated components that may be performed by a computing device such as the computing device in FIG. 5, arranged in accordance with at least some embodiments described herein.

Example methods may include one or more operations, functions or actions as illustrated by one or more of blocks 622, 624, 626, and/or 628. The operations described in the blocks 622 through 628 may also be stored as computer-executable instructions in a computer-readable medium such as a computer-readable medium 620 of a computing device 610.

An example process to fabricate a device with multiple integrated components may begin with block 622, “FORM A SUBSTRATE,” where a substrate may be formed from a first material. The first material may include ceramic, silicon, metal oxide, gallium arsenide, glass, polymer, and/or resin, for example. The substrate may be configured to provide a mechanical fixture for placing optoelectronic components. In some embodiments, a recession may be formed in the substrate using DRIE, for example, where the recession may be positioned centrally on the substrate.

Block 622 may be followed by block 624, “POSITION ONE OR MORE PHOTO DETECTORS ON A SURFACE OF THE SUBSTRATE,” where the photo detectors may be positioned centrally on a surface of substrate through wire bonding or chip flip bonding accommodated by at least one electrical connection formed on the surface of the substrate. In other examples, the photo detectors may be positioned on the surface of the substrate in a linear array or in a two-dimensional arrangement, such as a square array or a hexagonal array.

Furthermore, in some embodiments, the photo detectors may be positioned within the recession formed in the substrate such that the photo detectors are a greater distance away from the surface of the substrate compared to light sources positioned on the substrate. As a result of the position of the photo detectors within the recession, direct light transmission from the light sources to the photo detectors may be reduced, and accordingly, light other than reflected light from a portion of an object illuminated by the light sources may be reduced.

The photo detectors may include photodiodes, photomultiplier tubes, CMOS image sensors, CCDs, and/or micro-channel plates, for example. The photo detectors may be configured to detect the reflected light from the portion of the object in response to the illumination by the light sources.

In some embodiments, the reflected light may be analyzed to determine a spectral profile of the portion of the object, where the spectral profile may be used to further determine an identity and/or one or more characteristics of the object. In some examples, the photo detectors may be associated with, or function as, a distance ranging element configured to determine a distance to the portion of the object illuminated, where a three-dimensional surface topography of the object may be determined and portions thereof associated with spectral profile.

Block 624 may be followed by block 626, “POSITION LIGHT SOURCES ON THE SURFACE OF THE SUBSTRATE SUCH THAT EACH OF THE PHOTO DETECTORS HAS A PLURALITY OF ADJACENT LIGHT SOURCES,” where light sources may be positioned on the surface of the substrate through wire bonding or chip flip bonding accommodated by the electrical connection formed on the surface of the substrate. The light sources may be positioned such that each of the photo detectors has a plurality of adjacent light sources having different emission spectra. In some examples, the light sources may surround the photo detectors.

The light sources may include LEDs, laser diodes, white light sources, UV light sources, infrared light sources, red light sources, orange light sources, yellow light sources, green light sources, blue light sources, and/or violet light sources, for example. The light sources may be configured to illuminate at least one portion of the object with light at a variety of wavelengths in a sequential order or a random order for a pre-defined period of time. In some examples, the light sources may be selected based on an identity and/or color of the object being illuminated.

Block 626 may be followed by block 628, “APPLY A STRUCTURE TO THE SUBSTRATE ADJACENT TO EACH OF THE PHOTO DETECTORS SUCH THAT DIRECT LIGHT TRANSMISSION FROM THE LIGHT SOURCES TO THE PHOTO DETECTORS IS REDUCED,” where structures may be applied to the substrate adjacent to each of the photo detectors to reduce the direct light transmission from the light sources to the photo detectors. For example, the structure may be configured to reduce light other than the reflected light from the portion of the object in response to the illumination. The structures may include the recession formed in the substrate, as previously discussed. Additional structures may include a second material deposited on the surface of the substrate such that the second material encompasses the light sources and the photo detectors, and a protrusion formed from the first material and positioned centrally on the surface of the substrate such that the protrusion substantially surrounds the photo detectors.

The blocks included in the above described process are for illustration purposes. Fabrication of a device with multiple integrated components may be implemented by similar processes with fewer or additional blocks. In some embodiments, the blocks may be performed in a different order. In some other embodiments, various blocks may be eliminated. In still other embodiments, various blocks may be divided into additional blocks, or combined together into fewer blocks.

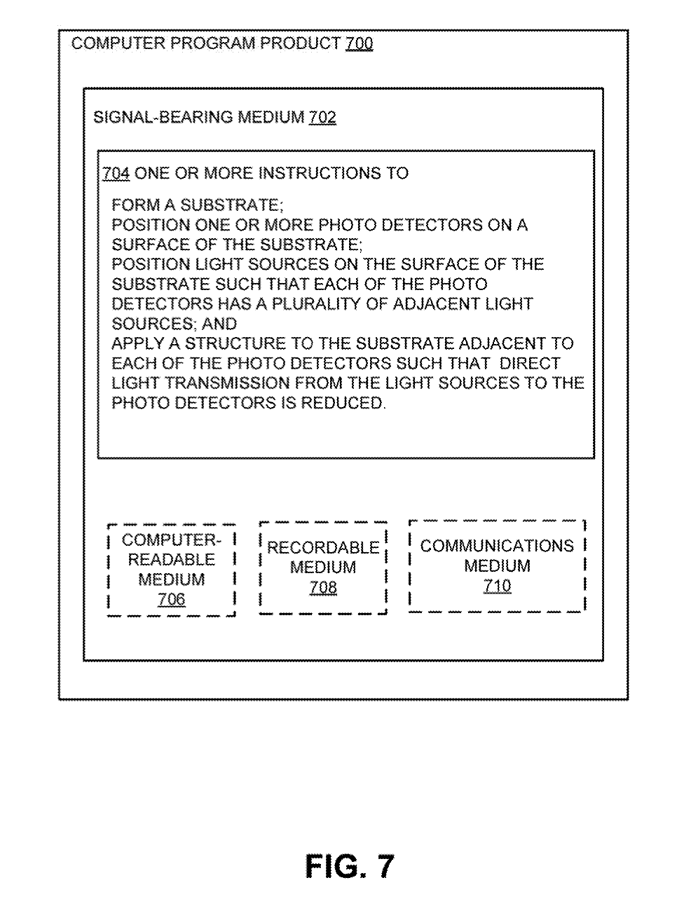

FIG. 7 illustrates a block diagram of an example computer program product, all arranged in accordance with at least some embodiments described herein.

In some embodiments, as shown in FIG. 7, the computer program product 700 may include a signal bearing medium 702 that may also include one or more machine readable instructions 704 that, when executed by, for example, a processor, may provide the functionality described herein. Thus, for example, referring to the processor 504 in FIG. 5, a fabrication module 526 executed on the processor 504 may undertake one or more of the tasks shown in FIG. 7 in response to the instructions 704 conveyed to the processor 504 by the medium 702 to perform actions associated with fabrication of a device with multiple integrated components. Some of those instructions may include, for example, one or more instructions to form a substrate, position one or more photo detectors on a surface of the substrate, position light sources on the surface of the substrate such that each of the photo detectors has a plurality of adjacent light sources, and apply a structure to the substrate adjacent to each of the photo detectors such that direct light transmission from the light sources to the photo detectors is reduced, according to some embodiments described herein.

In some implementations, the signal bearing medium 702 depicted in FIG. 7 may encompass a computer-readable medium 706, such as, but not limited to, a hard disk drive, a solid state drive, a Compact Disc (CD), a Digital Versatile Disk (DVD), a digital tape, memory, etc. In some implementations, the signal bearing medium 702 may encompass a recordable medium 708, such as, but not limited to, memory, read/write (R/W) CDs, R/W DVDs, etc. In some implementations, the signal bearing medium 702 may encompass a communications medium 710, such as, but not limited to, a digital and/or an analog communication medium (for example, a fiber optic cable, a waveguide, a wired communications link, a wireless communication link, etc.). Thus, for example, the program product 700 may be conveyed to one or more modules of the processor 504 of FIG. 5 by an RF signal bearing medium, where the signal bearing medium 702 is conveyed by the wireless communications medium 710 (for example, a wireless communications medium conforming with the IEEE 802.11 standard).

According to some examples, apparatuses with multiple integrated components may be described. An example apparatus may include a substrate, one or more photo detectors positioned on a surface of the substrate, and light sources positioned on the surface of the substrate, where the light sources are arranged such that each photo detector has a plurality of adjacent light sources. The example apparatus may also include a structure positioned on the substrate adjacent to each photo detector, the structure configured to reduce direct light transmission from the light sources to the one or more photo detectors.

In other examples, the apparatus may include a control circuit configured to detect a signal from at least one photo detector while sequentially illuminating each light source of the plurality of light sources adjacent to each photo detector. The plurality of light sources may be light emitting diodes (LEDs) and/or laser diodes. The plurality of light sources may include white light sources, ultraviolet (UV) light sources, infrared light sources, red light sources, orange light sources, yellow light sources, green light sources, blue light sources, and/or violet light sources. The photo detectors may be photodiodes, photomultiplier tubes, complementary metal oxide semiconductor (CMOS) image sensors, charged coupled devices (CCDs), and/or micro-channel plates. The structure applied to the substrate may include a material deposited on the surface of the substrate such that the material encompasses the plurality of light sources and the one or more photo detectors, where the material may include a glass, a plastic, and/or a polymer. The structure may also include one or more optical elements that are one of etched or embossed on the material, where the optical elements may include lenses, reflectors, and/or partial reflectors that are configured to reflect light, partially reflect light, and/or occlude light.

In further examples, the structure applied to the substrate may include a protrusion positioned centrally on the surface of the substrate and configured to substantially surround the photo detectors. The structure applied to the substrate may include a recession positioned centrally on the surface of the substrate such that the photo detectors are positioned at a greater distance away from the surface compared to the light sources. The apparatus includes at least one electrical connection on one or more surfaces of the substrate. The light sources and the photo detectors may be positioned on at least one surface of the substrate through wire bonding or flip chip bonding. The electrical connection on an opposite surface of the substrate from the light sources and the photo detectors may allow attachment of the substrate to an electronic printed circuit board (PCB). The apparatus may include one or more polarizing elements integrated with the light sources and the photo detectors configured to provide a glare control, a discrimination of roughness variations, and/or a relative stress indication. The apparatus may also include at least one light blocking filter configured to further reduce the direct light transmission from the light sources to the one or more photo detectors. The apparatus may be integrated with a camera, a flashlight, a pen, a smart phone, and a Radio-Frequency Identification (RFID) scanner.

According to some embodiments, methods to fabricate a multi-component apparatus are provided. An example method may include forming a substrate, positioning one or more photo detectors on a surface of the substrate, and positioning light sources on the surface of the substrate, where the light sources are arranged such that each photo detector has a plurality of adjacent light sources. The example method may also include applying a structure on the substrate adjacent to each photo detector, the structure configured to reduce direct light transmission from the light sources to the photo detectors.

In other embodiments, the substrate may be formed from a first material including of ceramic, silicon, metal oxide, gallium arsenide, a glass, a polymer, and/or a resin. Applying the structure to the substrate may include depositing a second material on the surface of the substrate such that the second material encompasses the light sources and the photo detectors. Applying the structure to the substrate may include forming a protrusion in a central position on the surface of the substrate such that the protrusion substantially surrounds the photo detectors and excludes the light sources, wherein the protrusion is formed on the surface of the substrate using a first material. Applying the structure to the substrate may include forming a recession in a central position on the surface of the substrate such that the photo detectors are positioned at a greater distance away from the surface compared to the light sources. At least one electrical connection may be formed on one or more surfaces of the substrate by patterning and metallizing the surfaces of the substrate, wherein metallizing the one or more surfaces of the substrate includes depositing one or more of gold, tin, solder, copper, silver, titanium, chrome, tungsten and aluminum.

According to some examples, methods to employ an apparatus with multiple integrated components are provided. An example method may include illuminating at least one portion of an object with light at a variety of wavelengths from a plurality of light sources positioned on a surface of a substrate, and detecting reflected light from the portion of the object in response to the illumination at one or more photo detectors positioned on the surface of the substrate. The example method may also include reducing light directed to the photo detectors other than the reflected light from the portion of the object illuminated by the plurality of light sources through a structure applied to the substrate adjacent to the photo detectors.

In other examples, illuminating the portion of the object includes illuminating the portion of the object with light at the variety of wavelengths from the plurality of light sources in a sequential order or a random order for a pre-defined time period. The reflected light may be analyzed to determine a spectral profile of the portion of the object. One or more of an identity and a characteristic of the object may be determined based on the spectral profile. A voltage or a current supplied to one or more of the light sources may be adjusted to cause a peak wavelength of the light sources to shift, where the shift in the peak wavelength of the light sources may allow the light sources to emit light at a different wavelength such that the portion of the object is sequentially illuminated with light at the variety of wavelengths.

In some examples, an apparatus with multiple integrated components comprises a substrate, one or more photo detectors positioned on a surface of the substrate, light sources positioned on the surface of the substrate, wherein the light sources are arranged such that each photo detector has a plurality of adjacent light sources; and optionally a structure positioned on the substrate adjacent to each photo detector, the structure configured to reduce direct light transmission from the light sources to the one or more photo detectors. An apparatus may further comprise a control circuit, wherein the control circuit is configured to detect a signal from at least one photo detector while sequentially illuminating each light source of the plurality of light sources adjacent to each photo detector. In some examples, each photo detector has a plurality of adjacent light sources, the plurality of adjacent light sources comprising light sources having different emission spectra. For example, a plurality of adjacent light sources may comprise LEDs of different color, such as a near-IR LED, a red LED, a yellow LED, a green LED, a blue LED, a violet LED, a UV LED, other color LED, and the like. In some examples, a light source may be a multi-color light source, such as a multi-color LED. In some examples, each photo detector may be associated with an adjacent multi-color LED.

In some examples, an apparatus may comprise a linear array of photo detectors, each photo detector having a plurality of adjacent light sources. A linear array may be translated over a sample of interest (for example, along a direction orthogonal to the direction of elongation of the array) to obtain spectral data from a two-dimensional array of sample areas on a surface of a sample. In some examples, an apparatus may comprise a two-dimensional arrangement of photo detectors (for example, a two-dimensional array such as a square array, hexagonal array, and the like, with each photo detector having a plurality of adjacent light sources. The apparatus may be placed adjacent a sample to be identified and/or authenticated, and spectral data from a two-dimensional array of sample areas on the surface of the sample may be obtained.

In some examples, one or more optical elements may be configured to direct light from each of the light sources on to a sample, where reflected or otherwise returned light (such as fluorescence) is then returned through the one or more optical elements to the photo detector. In some examples, an apparatus may comprise a plurality of photo detectors, each photo detector having a plurality of adjacent light sources, and a converging lens configured so that the photo detector and plurality of adjacent light sources are at least approximately located on or proximate the focal plane of the lens. Light from each of the plurality of adjacent light sources may be sequentially illuminated, for example illuminating the sample surface. Light reflected from the sample surface may then be returned from the sample surface, incident on the lens, and then at least approximately focused on the photo detector.

In some examples, a first photo detector may share at least one of the adjacent light sources with a proximate second photo detector. In some examples, light sources associated with a first photo detector may be sequentially illuminated, and corresponding first spectral data collected. Second spectral data may then be obtained for a proximate second photo detector using some of the light sources illuminated for collection of the first spectral data, along with other light sources.

In some examples, an apparatus may further function as a color emissive display. A color emissive display may provide the light sources, and the color emissive display may further function as a spectral analyzer using sequential illumination of light sources with collection of e.g. reflected light intensity using one or more photo detectors.

In some examples, an apparatus may further function as an image sensor, or a device including an image sensor such as a camera. Image data may be collected from a plurality of photo detectors, in some examples on sequential illumination of light sources having the same color. For example, all red light sources may be illuminated together, and an image corresponding to red illumination may be collected using the corresponding photo detector signals. Then, for example, all blue light sources may be illuminated, and corresponding reflectance data may be collected for each photo detector. Spectral image data may be collected as a plurality of images under different color light illumination, e.g. including one or more of UV, violet, blue, cyan, green, yellow, orange, red, and/or near-IR illumination. In some examples, time-dependent data may be collected, and in some examples the apparatus may be a spectral analyzing video camera. In some examples, UV, violet, and/or blue illumination may be used to collect fluorescence data.

In some examples, an apparatus may further function as a scanner. An apparatus may have a transparent support surface configured to receive a document, such as a legal document, such as a seal, banknote, and the like. Spectral analysis of the document (or other sample) over its area may be used to verify the authenticity of the document. In some examples, a document authenticating feature may include a particular spectral response over the area of the document.

In some examples, each photo detector may be associated with, or function as, a distance ranging element. For example, ultrasound transducers or IR distance sensors may be used to determine the distance to the sample area. The three-dimensional surface topography of the sample may be determined and portions thereof associated with measured spectral data.

### EXAMPLES

Following are illustrative examples of how some embodiments may be implemented, and are not intended to limit the scope of embodiments in any way.

### Example 1

### Camera Integrated with Wafer Comprising Multi-Component Devices with Deposited Material for Evaluation of Unknown Biological Specimen

A wafer, about 200 millimeters (mm) in diameter, includes a multitude of multi-component devices and is integrated with a camera employed to evaluate an unknown biological specimen. Each device includes a substrate, one or more electrical connections, a multitude of light sources, one or more photo detectors, and a structure comprising a second material deposition that is applied to the substrate.

The substrate is formed from a first material that includes silicon, and is configured to provide a mechanical fixture for placing optoelectronic components. The electrical connections are on two opposite surfaces of the substrate. The electrical connections on a first surface of the substrate include bonding pads configured to accommodate positioning of the light sources and photo detectors on the first surface of the substrate. The electrical connections on the opposite surface of the substrate allows attachment of the opposite surface of the substrate to an electronic printed circuit board (PCB). The electrical connections are formed on the surfaces of the substrate by patterning and metallizing the surfaces of the substrate, where the metallization may include depositing tin.

The light sources and the photo detectors are positioned on the surface of the substrate through wire bonding, where the light sources are arranged such that the each of the photo detectors has a multitude of adjacent light sources. The light sources include multi-color light emitting diodes (LEDs), including red LEDs, orange LEDs, yellow LEDs, green LEDs, blue LEDs, and violet LEDs, configured to illuminate at least one portion of a biological specimen with light at a variety of wavelengths in a sequential order for a pre-defined period of time. The photo detectors include complementary metal oxide semiconductor (CMOS) image sensors configured to detect reflected light from the portion of the biological specimen in response to the illumination. The reflected light is analyzed to determine a spectral profile of the portion of the biological specimen, where the spectral profile is used to further determine an identity of the biological specimen. In addition to detecting the reflected light, the CMOS image sensors are configured to collect images at each illumination wavelength. The CMOS image sensors are color sensitive at a particular illumination wavelength, accordingly, when the LEDs illuminate the portion of the biological specimen at the particular wavelength, the CMOS image sensors may be turned off and other sensors may be used to image, including UV light sources.

The structure applied to the substrate comprising the second material is deposited on the surface of the substrate adjacent to the CMOS image sensors such that the second material encompasses the LEDs and the CMOS image sensors, where the second material is glass. Optical elements are etched or embossed on the second material, where the optical elements include lenses, reflectors, and partial reflectors that are configured to reflect light, partially reflect light, and occlude light. The structure is applied to the substrate to reduce direct light transmission from the LEDs to the CMOS image sensors such that light directed to the CMOS image sensors other than the reflected light from the portion of the biological specimen in response to the illumination is reduced.

### Example 2

### Multi-Component Device with Protrusion Integrated with a Smart Phone for Evaluation of an Authenticity of a Passport

A smart phone is integrated with a multi-component device configured to evaluate an authenticity of a passport. The device includes a substrate, an electrical connection, a multitude of light sources, a photo detector, and a structure comprising a protrusion that is applied to the substrate.

The substrate is formed from a first material that includes ceramic, and is configured to provide a mechanical fixture for placing optoelectronic components. The electrical connection is on a surface of the substrate to accommodate a positioning of optoelectronic components, such as the light sources and the photo detector, on the surface of the substrate. The electrical connections are formed on the surface of the substrate by patterning and metallizing the surface of the substrate, where the metallization includes depositing gold.

The light sources and the photo detector are positioned on the surface of the substrate through flip chip bonding, where the photo detector is positioned centrally such that the light sources surround the photo detector. The light sources include laser diodes configured to illuminate at least one portion of the passport, with light at a variety of wavelengths in a random order for a pre-defined period of time. The photo detector is a charged coupled device (CCD) configured to detect reflected light from the portion of the passport in response to the illumination. Polarizing elements are integrated with the light sources and the photo detectors to provide a glare control, a discrimination of roughness variations, and a relative stress indication. The reflected light is analyzed to determine a spectral profile of the portion of the passport, where the spectral profile is used to further determine an authenticity of the passport.

The structure applied to the substrate comprising the protrusion is formed from the first material and positioned centrally on the surface of the substrate such that the protrusion substantially surrounds the CCD and excludes the laser diodes. The structure is applied to the substrate to reduce direct light transmission from the laser diodes to the CCD, and accordingly reduce light directed to the CCD other than the reflected light from the portion of the passport.

### Example 3

### Flashlight Integrated with Multi-Component Device with Recession for Evaluation of Quality of Fuel

A flashlight is integrated with a multi-component device configured to evaluate a quality of a fuel sample based on a presence and/or absence of contaminants. The device includes a substrate, an electrical connection, a multitude of light sources, one or more photo detectors, and a structure comprising a recession that is applied to the substrate.

The substrate is formed from a first material that includes resin, and is configured to provide a mechanical fixture for placing optoelectronic components. The electrical connection includes bonding pads, and is formed on a surface of the substrate to accommodate a positioning of optoelectronic components, such as the light sources and photo detectors, on the surface of the substrate. The electrical connections are formed on the surface of the substrate by patterning and metallizing the surface of the substrate, where the metallization includes depositing aluminum.

The light sources and the photo detectors are positioned on the surface of the substrate through wire bonding and flip chip bonding, where the light sources are arranged such that each of the photo detectors has a multitude of adjacent light sources. The light sources include UV light sources configured to illuminate at least one portion of the fuel sample, with light. The photo detectors include photodiodes configured to detect reflected light from the portion of the fuel sample in response to the illumination. The reflected light is analyzed to determine a spectral profile of the portion of the fuel sample, where the spectral profile is used to further determine a quality of the fuel sample based on a presence and/or absence of contaminants.

The structure applied to the substrate comprising the recession is formed in the substrate using Deep Reactive Ion Etching (DRIE). The recession is positioned centrally on the surface of the substrate. The structure is applied to the substrate to reduce direct light transmission from the UV light sources to the photodiodes, and accordingly reduce light directed to the photodiodes other than the reflected light from the portion of the fuel sample in response to the illumination. Furthermore, the device includes a light blocking filter configured to further reduce direct light transmission from the UV light sources to the photodiodes.

There are various vehicles by which processes and/or systems and/or other technologies described herein may be effected (for example, hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

While various compositions, methods, systems, and devices are described in terms of “comprising” various components or steps (interpreted as meaning “including, but not limited to”), the compositions, methods, systems, and devices can also “consist essentially of” or “consist of” the various components and steps, and such terminology should be interpreted as defining essentially closed-member groups.”

The foregoing detailed description has set forth various embodiments of the devices and/or processes via the use of block diagrams, flowcharts, and/or examples. Insofar as such block diagrams, flowcharts, and/or examples contain one or more functions and/or operations, each function and/or operation within such block diagrams, flowcharts, or examples may be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, some aspects of the embodiments disclosed herein, in whole or in part, may be equivalently implemented in integrated circuits, as one or more computer programs running on one or more computers (for example, as one or more programs running on one or more computer systems), as one or more programs running on one or more processors (for example as one or more programs running on one or more microprocessors), as firmware, or as virtually any combination thereof, and that designing the circuitry and/or writing the code for the software and or firmware would be possible in light of this disclosure.

The present disclosure is not to be limited in terms of the particular embodiments described in this application, which are intended as illustrations of various aspects. Many modifications and variations can be made without departing from its spirit and scope. Functionally equivalent methods and apparatuses within the scope of the disclosure, in addition to those enumerated herein, will be possible from the foregoing descriptions. Such modifications and variations are intended to fall within the scope of the appended claims. The present disclosure includes the terms of the appended claims, along with the full scope of equivalents to which such claims are entitled. It is to be understood that this disclosure is not limited to particular methods, systems, or components, which can, of course, vary. It is also to be understood that the terminology used herein is for the purpose of describing particular embodiments only, and is not intended to be limiting.

In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Versatile Disk (DVD), a digital tape, a computer memory, etc.; and a transmission type medium such as a digital and/or an analog communication medium (for example, a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that particular functionality is achieved. Hence, any two components herein combined to achieve a particular functionality may be seen as “associated with” each other such that the particular functionality is achieved, irrespective of architectures or intermediate components. Likewise, any two components so associated may also be viewed as being “operably connected”, or “operably coupled”, to each other to achieve the particular functionality, and any two components capable of being so associated may also be viewed as being “operably couplable”, to each other to achieve the particular functionality. Specific examples of operably couplable include but are not limited to physically connectable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations).

Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

While various aspects and embodiments have been disclosed herein, other aspects and embodiments are possible. The various aspects and embodiments disclosed herein are for purposes of illustration and are not intended to be limiting, with the true scope and spirit being indicated by the following claims.

1. An apparatus with multiple integrated components, the apparatus comprising:
a substrate;
one or more photo detectors positioned on a surface of the substrate;
light sources positioned on the surface of the substrate, wherein the light sources are arranged such that each photo detector has a plurality of adjacent light sources; and
a structure positioned on the substrate adjacent to each photo detector, the structure configured to reduce direct light transmission from the light sources to the one or more photo detectors, wherein the structure comprises one or more of a material deposited on the surface of the substrate, a protrusion in a central position on the surface of the substrate, and a recession in the central position on the surface of the substrate.

2. The apparatus of claim 1, further comprising a control circuit, wherein the control circuit is configured to detect a signal from at least one photo detector while sequentially illuminating each light source of the plurality of light sources adjacent to each photo detector.

3. The apparatus of claim 1, wherein the plurality of light sources are one or more of light emitting diodes (LEDs) and laser diodes, and are one or more of white light sources, ultraviolet (UV) light sources, infrared light sources, red light sources, orange light sources, yellow light sources, green light sources, blue light sources, or violet light sources.

4. (canceled)

5. The apparatus of claim 1, wherein the one or more photo detectors are one or more of photodiodes, photomultiplier tubes, complementary metal oxide semiconductor (CMOS) image sensors, charged coupled devices (CCDs), and micro-channel plates.

6. (canceled)

7. The apparatus of claim 1, wherein the material comprises one or more of a glass, a plastic, and a polymer.

8. The apparatus of claim 1, further comprising one or more optical elements that are one of etched or embossed on the material, wherein the optical elements include one or more of lenses, reflectors, and partial reflectors that are configured to one of reflect light, partially reflect light, or occlude light.

9.-11. (canceled)

12. The apparatus of claim 1, further comprising at least one electrical connection on one or more surfaces of the substrate.

13. The apparatus of claim 12, wherein the plurality of light sources and the one or more photo detectors are positioned on at least one surface of the substrate through one of wire bonding and flip chip bonding.

14. The apparatus of claim 12, wherein the electrical connection on an opposite surface of the substrate from the plurality of light sources and the one or more photo detectors allow attachment of the substrate to an electronic printed circuit board (PCB).

15. The apparatus of claim 1, further comprising:
one or more polarizing elements integrated with the plurality of light sources and the one or more photo detectors configured to provide one or more of a glare control, a discrimination of roughness variations, and a relative stress indication; and
at least one light blocking filter configured to further reduce the direct light transmission from the light sources to the one or more photo detectors.

16. (canceled)

17. The apparatus of claim 1, wherein the apparatus is integrated with a camera, a flashlight, a pen, a smart phone, and a Radio-Frequency Identification (RFID) scanner.

18. A method to fabricate a multi-component apparatus, the method comprising:
forming a substrate from a first material;
positioning one or more photo detectors on a surface of the substrate;
positioning light sources on the surface of the substrate, wherein the light sources are arranged such that each photo detector has a plurality of adjacent light sources; and
applying a structure on the substrate adjacent to each photo detector, the structure configured to reduce direct light transmission from the light sources to the one or more photo detectors, wherein the structure comprises one or more of a second material deposited on the surface of the substrate, a protrusion in a central position on the surface of the substrate, and a recession in the central position on the surface of the substrate.

19. The method of claim 18, wherein forming the substrate comprises:
forming the substrate from the first material including one or more of ceramic, silicon, metal oxide, gallium arsenide, a glass, a polymer, or a resin.

20. The method of claim 18, wherein applying the structure to the substrate comprises:
depositing the second material on the surface of the substrate such that the second material encompasses the plurality of light sources and the one or more photo detectors.

21. The method of claim 18, wherein applying the structure to the substrate comprises:
forming the protrusion in the central position on the surface of the substrate such that the protrusion substantially surrounds the one or more photo detectors and excludes the plurality of light sources, wherein the protrusion is formed using the first material used to form the substrate.

22. (canceled)

23. The method of claim 18, wherein applying the structure to the substrate comprises:
forming the recession in the central position on the surface of the substrate such that the one or more photo detectors are positioned at a greater distance away from the surface compared to the plurality of light sources.

24. The method of claim 18, further comprising:
forming at least one electrical connection on one or more surfaces of the substrate by patterning and metallizing the one or more surfaces of the substrate, wherein metallizing the one or more surfaces of the substrate includes depositing one or more of gold, tin, solder, copper, silver, titanium, chrome, tungsten and aluminum.

25. (canceled)

26. A method to employ an apparatus with multiple integrated components, the method comprising:
illuminating at least one portion of an object with light at a variety of wavelengths from a plurality of light sources positioned on a surface of a substrate in one of a sequential order or a random order for a pre-defined time period;
detecting reflected light from the at least one portion of the object in response to the illumination at one or more photo detectors positioned on the surface of the substrate; and
reducing light directed to the one or more photo detectors other than the reflected light from the at least one portion of the object illuminated by the plurality of light sources through a structure applied to the substrate adjacent to the one or more photo detectors, wherein the structure comprises one or more of a material deposited on the surface of the substrate, a protrusion in a central position on the surface of the substrate, and a recession in the central position on the surface of the substrate.

27. (canceled)

28. The method of claim 26, further comprising:
analyzing the reflected light to determine a spectral profile of the at least one portion of the object; and
determining one or more of an identity and a characteristic of the object based on the spectral profile.

29. (canceled)

30. The method of claim 26, further comprising:
adjusting a voltage or a current supplied to one or more of the plurality of light sources to cause a peak wavelength of the one or more of the plurality of light sources to shift, wherein the shift in the peak wavelength of the one or more of the plurality of light sources allows the one or more of the plurality light sources to emit light at a different wavelength such that the at least one portion of the object is sequentially illuminated with light at the variety of wavelengths.

31. (canceled)
